(19) United States
(12) Patent Application Publication
(10) Pub. No.: US 2012/0183641 A1
(43) Pub. Date: Jul. 19, 2012

(54) MOLD RELEASING DEVICE

(75) Inventor: Hsin An Shih, Xiamen (CN)

(73) Assignee: TPV DISPLAY TECHNOLOGY (XIAMEN) CO., LTD., Xiamen (CN)

(21) Appl. No.: 13/008,530

(22) Filed: Jan. 18, 2011

(51) Int. Cl. B29C 45/44; B29C 33/44

(52) U.S. Cl. 425/577; 425/441

(57) ABSTRACT

A mold releasing device for protecting an inclined pole is provided. The mold releasing device comprises a movable core having an inclined hole and disposed inside a movable mold. The inclined pole is cubic shape and has a positioning face at upper side, wherein the positioning face approaches the upper face of the inclined hole. Two sides of middle of the inclined pole contain a trough and a roller unit, wherein the roller unit practices rolling friction and is corresponded to the inclined hole and disposed inside the trough. The lower side of the inclined pole contains a fastening element connected to upper end of a vertical bar. The lower end of the vertical bar contains a flange disposed at a circular orifice of a fixing plate, wherein the fixing plate is fixed to a pushing plate by means of a bolt. Whereby, the pushing plate and the vertical bar may push forward the inclined pole with tilted manner inside the inclined hole and eject a plastic product with laterally release.

### FIELD OF THE INVENTION

The present invention relates to a mold releasing device with movable inclined pole, particularly to the mold releasing device for producing a plastic product with barb, concave or convex structure.

### DESCRIPTION OF THE PRIOR ART

Plastic component, having barb, concave or convex structure in shape, in electronic products normally utilize fixing or fastening structure so as to connect or link with another components. Therefore the mechanical combination is therefore achieved. In order to produce the plastic component with barb, concave or convex structure, a specific mold with inclined pole is normally needed, so as to fabricate the plastic component with peculiar configuration inside the mold cavity. When this kind of plastic product is formed, an ejector pin is commonly utilized to eject the plastic product. Besides, such kind of peculiar shapes needs to be ejected as the mold cavity is opened, and meanwhile the inclined pole may move and urge the plastic product to release from the cavity.

In the existing technology, the inclined pole is normally cubic shaped and move against an inclined hole by friction. Therefore the movement of the inclined pole may result in tightly match and significant amount of kinetic friction between the inclined pole and neighborhood; and then the wear and tear in the exerting face is therefore increase. Moreover, expansion and contraction of the inclined pole resulted from temperature change may even worsen this condition, and sometimes the inclined pole stuck in the inclined hole may also happened. In this manner, the surface scratch of the inclined hole and fracture of the inclined pole is thus happened. Therefore, how to settle this problem is critical issue needed to be resolved.

### SUMMARY OF THE INVENTION

The primary object of present invention is to protect the inclined pole from breaking in expansion and contraction resulted from temperature difference, so as to extend the duration.

To achieve the foregoing and other objects, a mold releasing device for protecting an inclined pole is provided. The mold releasing device comprises a movable core containing an inclined hole and disposed inside a movable mold. The inclined pole is cubic shape and contains a positioning face at upper side, wherein the positioning face approaches the upper face of the inclined hole. Two sides of middle of the inclined pole contain a trough and a roller unit, wherein the roller unit practices rolling friction and is corresponded to the inclined hole and disposed inside the trough. The lower side of the inclined pole contains a fastening element connected to upper end of a vertical bar. The lower end of the vertical bar contains a flange disposed at a circular orifice of a fixing plate, wherein the fixing plate is fixed to a pushing plate by means of a bolt. Whereby, the pushing plate and the vertical bar may push forward the inclined pole with tilted manner inside the inclined hole and eject a plastic product with laterally release.

In the aforementioned mold releasing device, wherein the roller unit might be rolling column or rolling ball.

In the aforementioned mold releasing device, wherein the length of the trough is equal to half sliding distance of the inclined pole and length of the roller unit.

In the aforementioned mold releasing device, wherein the trough is disposed at two sides of middle of the inclined pole and is vertical to the axial direction of the roller unit; wherein two sides of the trough contains a groove and a flexible element sliding with the groove; wherein the flexible element contains a mouth corresponded to the roller unit, and the roller unit might be rolling column or rolling ball.

In the aforementioned mold releasing device, wherein middle of two sides of the inclined pole might be exerting face or non-exerting face.

In the aforementioned mold releasing device, wherein the pushing plate is supported by means of a movable mold if injection is progressed; wherein the pushing plate move downward coming along with a fixing plate and the movable mold, and then a ejector rod move upward to urge the pushing plate and inclined pole moving upward so as to eject the plastic product if the mold is opened; wherein the inclined pole go back to destination if the ejector rod moves downward coming along with the pushing plate and the inclined pole and then the pushing plate approaches the fixing plate.

In the aforementioned mold releasing device, wherein the vertical bar push the inclined pole to move to topmost of the inclined hole and the roller unit move to bottommost of the trough if the mold is opened; wherein the roller unit move to topmost of the trough if the vertical bar pulls the inclined pole back to the bottommost of the inclined hole.

Whereby, the mold releasing device of present invention may utilize roller unit to roll and move, instead of kinetic friction and move, so as to extend duration of the inclined pole.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is diagram of mold and inclined pole while in the condition of closed mold according to embodiment of present invention;

FIG. 1B is side-view diagram of mold and inclined pole while in the condition of closed mold according to embodiment of present invention;

FIG. 2A is diagram of inclined pole according to present invention; FIG. 2B is side-view diagram of inclined pole according to present invention;

FIG. 2C is locally enlarged diagram of area E in FIG. 2B;

FIG. 2D is N-N cross sectional view seen from top view of FIG. 2A;

FIG. 2E is locally enlarged diagram of area D in FIG. 2D;

FIG. 3 is diagram of the flexible element in present invention;

FIG. 4A is first diagram of opening mold and ejecting plastic product;

FIG. 4B is side view of first diagram of opening mold and ejecting plastic product;

FIG. 5A is second diagram of opening mold and ejecting plastic product;

FIG. 5B is side view of second diagram of opening mold and ejecting plastic product;

FIG. 6A is diagram showing return of the inclined pole according to present invention;

FIG. 6B is side view of diagram showing return of the inclined pole according to present invention;

FIG. 7A is diagram showing return and close of movable mold;

FIG. 7B is side view diagram showing return and close of movable mold.

### DESCRIPTION OF THE PREFERRED EMBODIMENTS

The present invention relates to a mold releasing device which may protect an inclined pole from being broken. The mold releasing device is used for fabricating a plastic product with barb, concave or convex structure, and then the plastic product is released and separated from the mold.

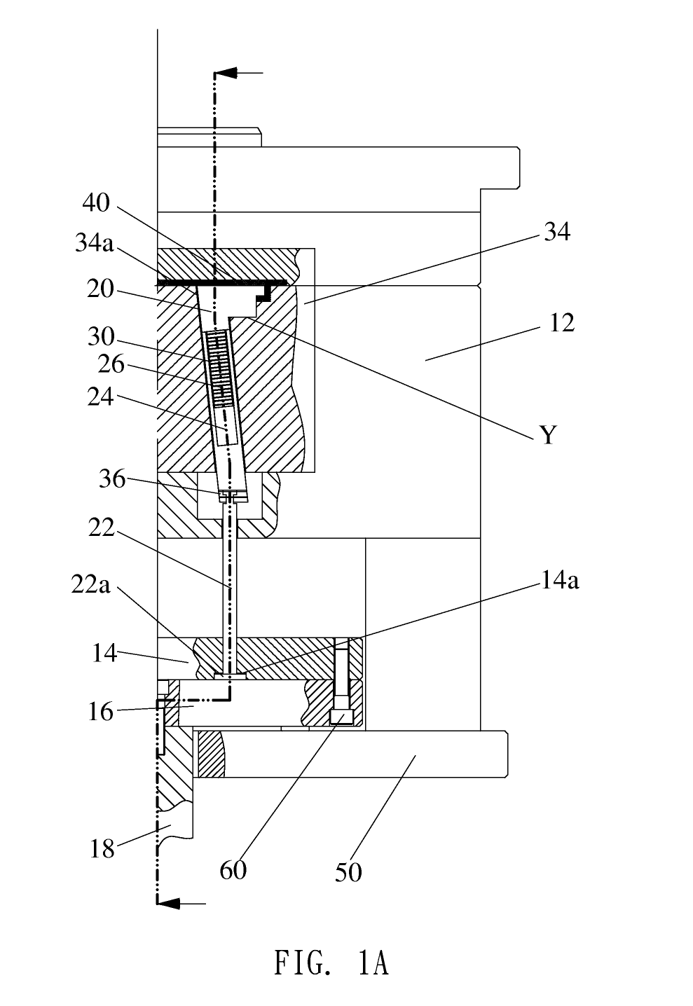

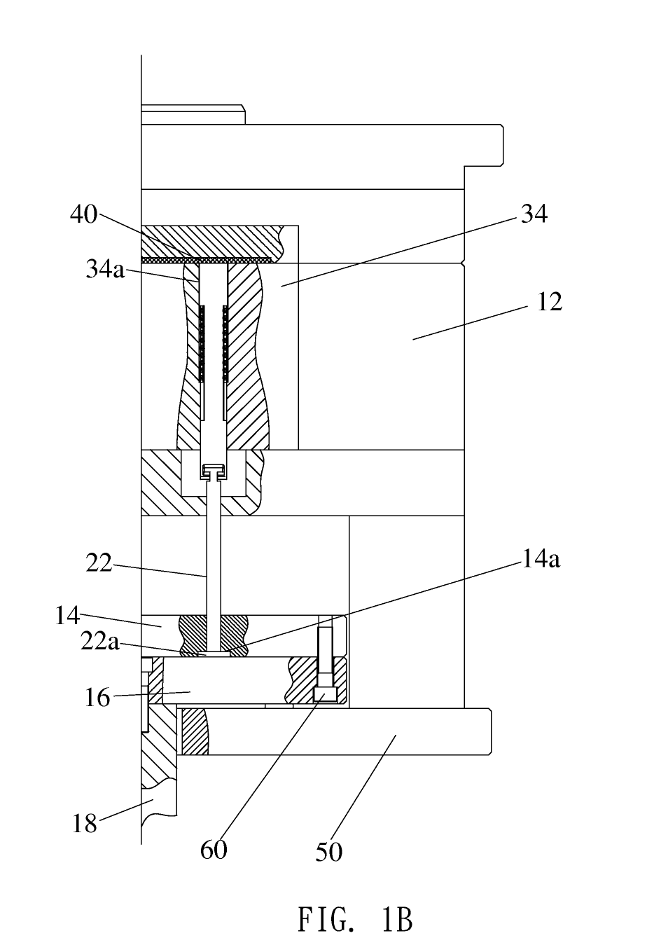

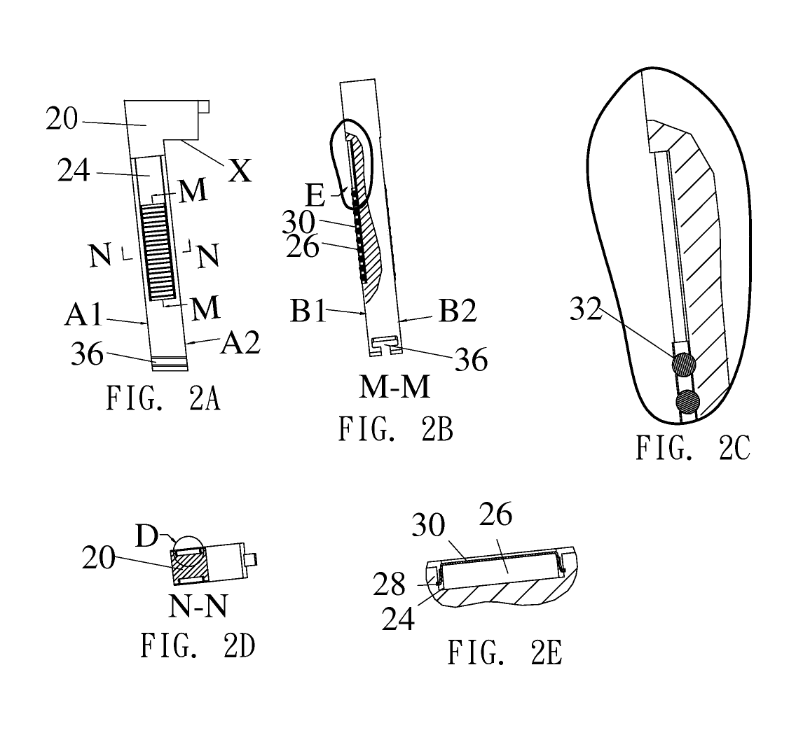

FIG. 1A is diagram of mold and inclined pole while in the condition of closed mold according to embodiment of present invention; FIG. 1B is side-view diagram of mold and inclined pole while in the condition of closed mold according to embodiment of present invention; FIG. 2A is diagram of inclined pole according to present invention; FIG. 2B is side-view diagram of inclined pole according to present invention; FIG. 2C is locally enlarged diagram of area E in FIG. 2B; FIG. 2D is N-N cross sectional view seen from top view of FIG. 2A; FIG. 2E is locally enlarged diagram of area D in FIG. 2D. Please refer to FIG. 1A, 1B, 2A, 2B, 2C and FIG. 2E, as shown in those diagrams:

Movable core 34 is disposed inside the movable mold and the movable mold is on the fixing plate 50. The movable core 34 has an inclined hole 34a which is tilted disposed inside the movable core 34. In practice, the tilted angle might be disposed according to real situation. The inclined hole 34a contains a cubic-shaped inclined pole 20 disposed inside. The positioning face X, disposed at upper end of the inclined pole 20, attaches to the upper face Y of the inclined hole 34a. Two sides B1 and B2 of middle of the inclined pole 20 contains a trough 24 and a roller unit 26, wherein the roller unit 26 practices rolling friction and is corresponded to the inclined hole 20 and disposed inside the trough 24. The lower side of the inclined pole 20 contains a fastening element 26 connected to upper end of a vertical bar 22. The lower end of the vertical bar 22 contains a flange 22a disposed at a circular orifice 14a of a fixing plate 14, wherein the fixing plate 14 is fixed to a pushing plate 16 by means of a bolt 60. In this manner, the pushing plate 16 and the vertical bar 22 may push forward the inclined pole 20 with tilted manner inside the inclined hole 34a and eject a plastic product 40 by laterally release.

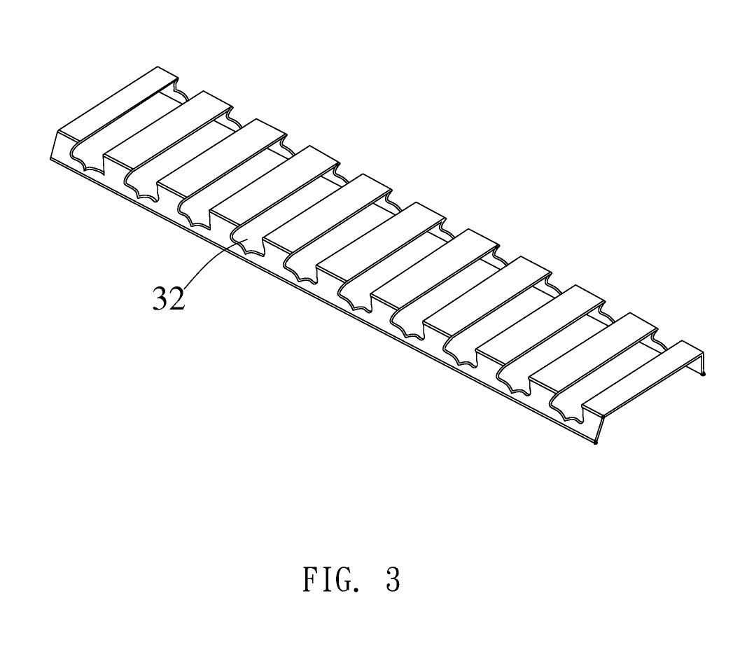

FIG. 3 is diagram of the flexible element in present invention; please refer to FIG. 3 as well as FIGS. 2A, 2B, 2C and FIG. 2E. As shown in those figures, the trough 24 is disposed at two sides of middle of the inclined pole 20 and is vertical to the axial direction of the roller unit 26. Two sides of the trough 24 contain a groove 28 and a flexible element 30, in which the flexible element 30 might slide with the groove 28. The flexible element 30 contains a mouth 32 corresponded to the roller unit 26. Middle of two sides of the inclined pole 20 might be exerting face A1, A2, or non-exerting face B1, B2. The roller unit 26 could be rolling column or rolling ball. Because of separation between the inclined pole 20 and the inclined hole 34a, which is separated by rolling column or rolling ball, the heat transfer between the inclined pole 20 and the inclined hole 34a is significantly reduced, so that the expansion and contraction resulted from temperature difference is therefore decreased. Wherein, the length of the trough 24 is equal to half sliding distance of the inclined pole 20 and length of the roller unit 26.

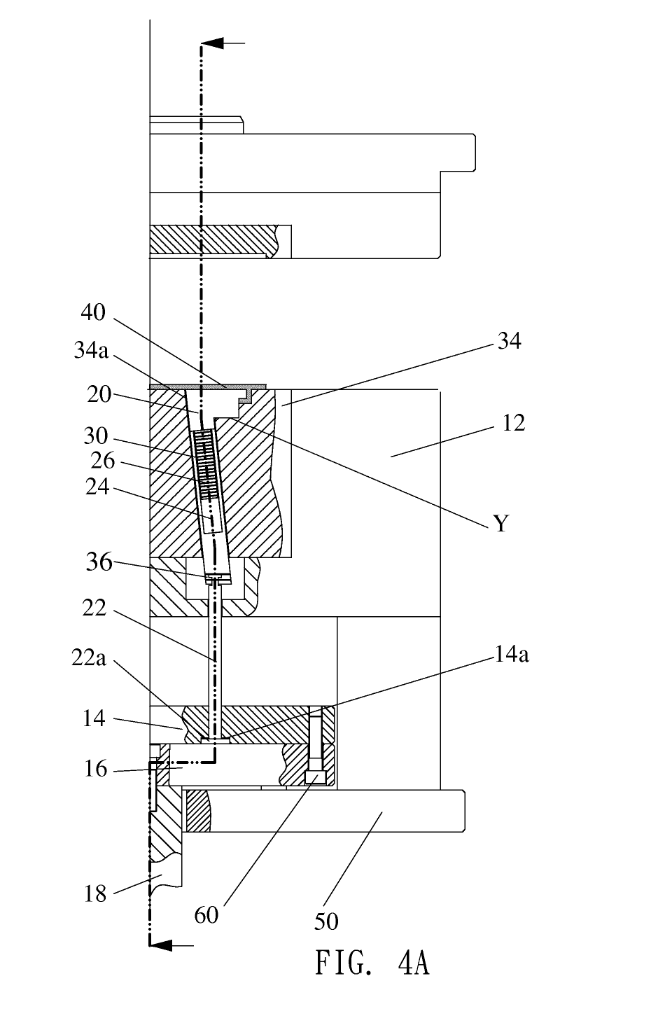

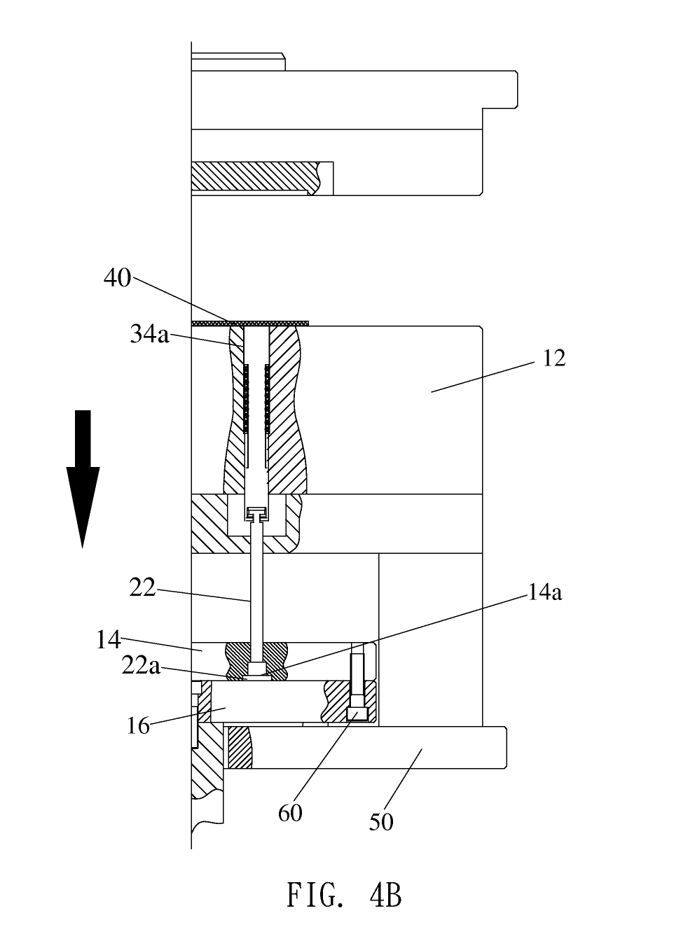

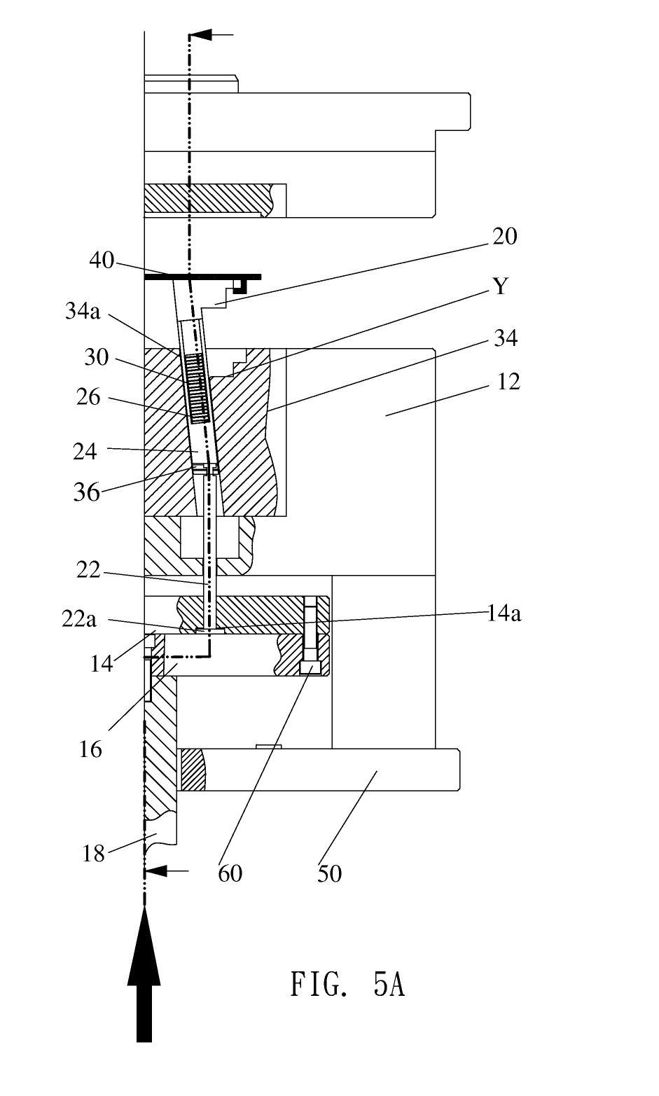

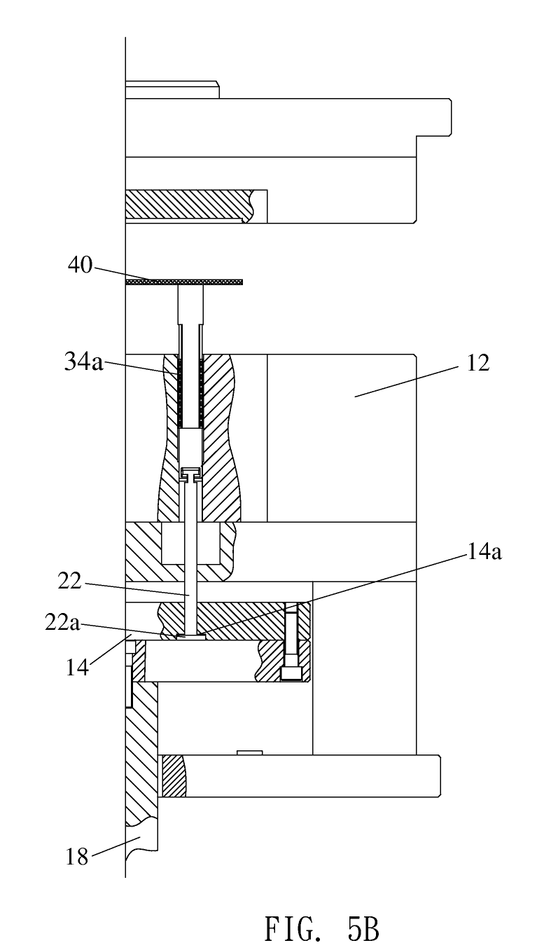

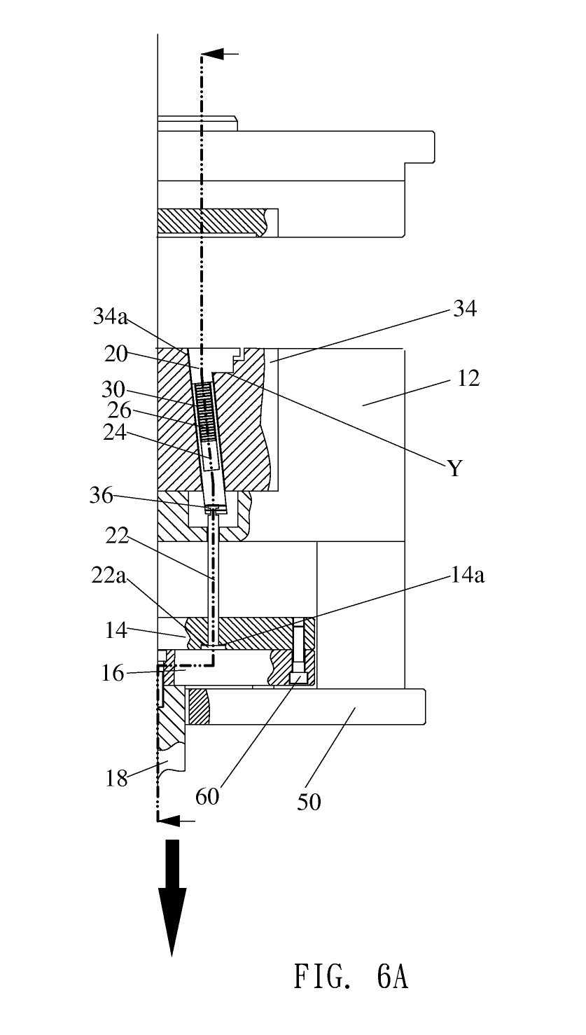

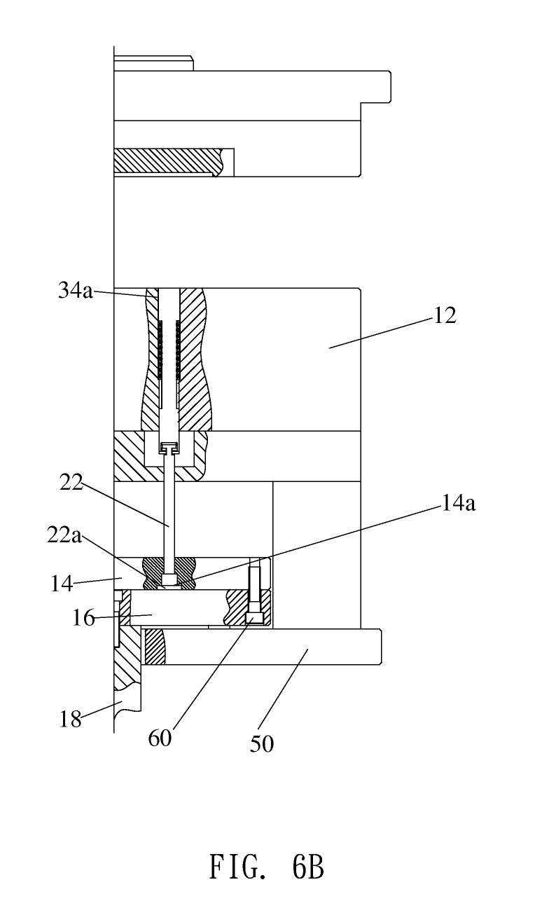

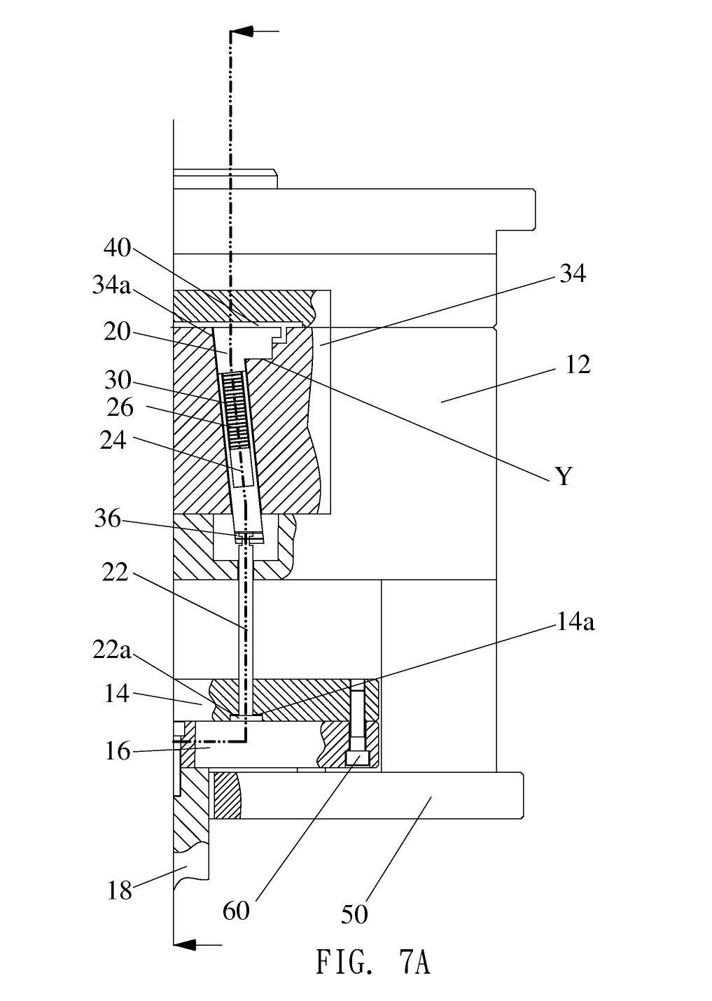

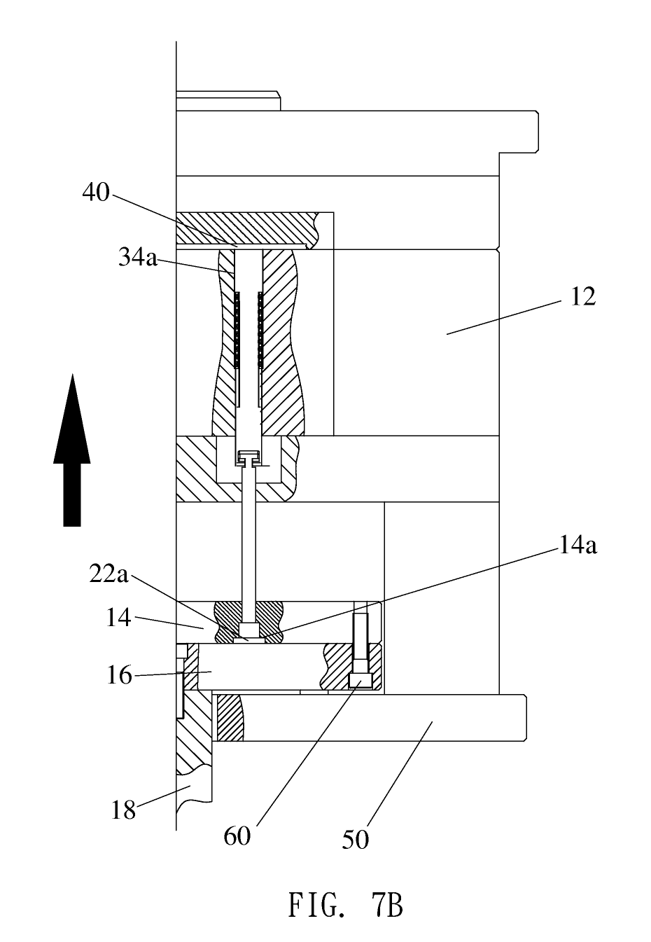

FIG. 4A is first diagram of opening mold and ejecting plastic product; FIG. 4B is side view of first diagram of opening mold and ejecting plastic product; FIG. 5A is second diagram of opening mold and ejecting plastic product; FIG. 5B is side view of second diagram of opening mold and ejecting plastic product; FIG. 6A is diagram showing return of the inclined pole according to present invention; FIG. 6B is side view of diagram showing return of the inclined pole according to present invention; FIG. 7A is diagram showing return and close of movable mold; FIG. 7B is side view diagram showing return and close of movable mold. Please refer to FIG. 4A-7B. As shown in FIG. 4A-5B, when the inclined pole 20 ejects, the inclined pole 20 might move upward 1 mm in the inclined hole 34a of the movable core 34, and meanwhile the roller unit 26 might correspondingly move upward 0.5 mm in the inclined hole 34a of the movable core 34. As shown in FIG. 6A and FIG. 6B, when the inclined pole 20 returns, the inclined pole 20 might go backward 1 mm in the inclined hole 34a, and meanwhile the roller unit 26 might also go backward 0.5 mm in the inclined hole 34a. In this manner, when the mold is opened, the vertical bar 22 might push the inclined pole 20 to move to topmost of the inclined hole 34a, and push the roller unit 26 to move to bottommost of the trough 24. When the vertical bar 22 pulls the inclined pole 20 back to the bottommost of the inclined hole 34a, the roller unit 26 might move to topmost of the trough 24.

In this embodiment, the roller unit 26 is rolling column. As shown in FIG. 7A and 7B, when the plastics injection is progressed, the pushing plate 16 is supported by means of the movable mold 12. As shown in FIG. 4A-5B, when the mold is opened, the pushing plate 16 moves downward coming along with a fixing plate 60 and the movable mold 12, and then a ejector rod 18 of the injection machine moves upward to urge the pushing plate 16 and inclined pole 20 going upward, so as to eject the plastic product 40. As shown in FIG. 6A-6B, when the ejector rod 18 moves downward, the pushing plate 16 and the inclined pole 20 are moved downward together. After the pushing plate 16 approaches the fixing plate 60, the inclined pole 20 goes back to final destination, wherein the final destination is indeed the initial position of closing mold.

Summarily, the mold releasing device of present invention may utilize roller unit to roll and move, instead of kinetic friction and move, so as to extend duration of the inclined pole.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

I claim:

1. A mold releasing device for protecting an inclined pole, comprising:
a movable core having an inclined hole and disposed inside a movable mold;
the inclined pole being cubic shape and having a positioning face at upper side, wherein the positioning face approaches the upper face of the inclined hole;
two sides of middle of the inclined pole containing a trough and a roller unit, wherein the roller unit practices rolling friction and is corresponded to the inclined hole and disposed inside the trough;
the lower side of the inclined pole containing a fastening element connected to upper end of a vertical bar;
the lower end of the vertical bar containing a flange disposed at a circular orifice of a fixing plate, wherein the fixing plate is fixed to a pushing plate by means of a bolt;
whereby, the pushing plate and the vertical bar may push forward the inclined pole with tilted manner inside the inclined hole and eject a plastic product by laterally release.

2. The mole releasing device as claim 1, wherein the roller unit might be rolling column or rolling ball.

3. The mold releasing device as claim 1, wherein the length of the trough is equal to half sliding distance of the inclined pole and length of the roller unit.

4. The mole releasing device as claim 1, wherein the trough is disposed at two sides of middle of the inclined pole and is vertical to the axial direction of the roller unit; wherein two sides of the trough contains a groove and a flexible element sliding with the groove; wherein the flexible element contains a mouth corresponded to the roller unit.

5. The mole releasing device as claim 4, wherein the roller unit might be rolling column or rolling ball.

6. The mole releasing device as claim 1, wherein middle of two sides of the inclined pole might be exerting face or non-exerting face.

7. The mole releasing device as claim 1, wherein the pushing plate is supported by means of a movable mold if injection is progressed; wherein the pushing plate move downward coming along with a fixing plate and the movable mold, and then a ejector rod move upward to urge the pushing plate and inclined pole moving upward so as to eject the plastic product if the mold is opened; wherein the inclined pole go back to destination if the ejector rod moves downward coming along with the pushing plate and the inclined pole and then the pushing plate approaches the fixing plate.

8. The mole releasing device as claim 1, wherein the vertical bar push the inclined pole to move to topmost of the inclined hole and the roller unit move to bottommost of the trough if the mold is opened; wherein the roller unit move to topmost of the trough if the vertical bar pulls the inclined pole back to the bottommost of the inclined hole.
